(19) United States
(12) Patent Application Publication
(10) Pub. No.: US 2023/0012153 A1
(43) Pub. Date: Jan. 12, 2023

(54) SELF-DUST EXTRACTION DUSTLESS MITER SAW

(71) Applicant: YONGKANG CONGZHEN TOOLS CO., LTD., Yongkang (CN)

(72) Inventor: Xiao WANG, Yongkang (CN)

(73) Assignee: YONGKANG CONGZHEN TOOLS CO., LTD., Yongkang (CN)

(21) Appl. No.: 17/452,811

(22) Filed: Oct. 29, 2021

(30) Foreign Application Priority Data
Jul. 6, 2021 (CN) 202110763841.8

(51) Int. Cl. B23D 59/00; B27G 19/02; B27B 5/29

(52) U.S. Cl. CPC B23D 59/006; B27G 19/02; B27B 5/29

(57) ABSTRACT

A self-dust extraction dustless miter saw includes a pedestal, a disc mounted on the pedestal, and a sawing mechanism installed above the disc, the sawing mechanism includes a saw blade, a blade guard installed above the saw blade, and an upper dust extraction channel; the upper dust extraction channel is arranged at a lower rear of the blade guard and is configured to extract a dust carried by the saw blade while cutting; the self-dust extraction dustless miter saw further includes a lower dust extraction channel, the lower dust extraction channel is mounted to a rear of the disc, a first end of the lower dust extraction is connected with the disc, and a second end of the lower dust extraction channel is connected with a self-dust extraction device of the self-dust extraction dustless miter saw through a pipe.

### CROSS-REFERENCE TO THE RELATED APPLICATIONS

This application is based upon and claims priority to Chinese Patent Application No. 202110763841.8 filed on Jul. 6, 2021, the entire contents of which are incorporated herein by reference.

### TECHNICAL FIELD

The present invention relates to the field of the technology of miter saw, in particular to a self-dust extraction dustless miter saw.

### BACKGROUND

Miter saws are widely used in mechanical fields and can be used to cut materials such as metal, wood, plastic board, and fiberboard. During actual cutting, a large amount of dust such as sawdust will inevitably be produced, which will have a certain impact on the health of the operator and cause great pollution to the surrounding environment. However, people expect a miter saw that has less impact on the environment and the health of workers, therefore, there is an urgent need for a miter saw that does not allow wood dust to pollute the environment. The miter saw generally comprises a base, a rotating disc mounted on the base, a sawing mechanism located above the rotating disc and the sawing mechanism having a motor and a saw blade, and a baffle plate mounted on the disc for positioning the workpieces, wherein the sawing mechanism is rotatably connected with the disc around a pivot shaft that is relatively fixed to the disc, to cut the workpiece. At present, the common miter saws with or without pull rods on the market have no self-dust extraction function, so the physical and mental health of the operators and the working environment cannot be guaranteed.

At present, there are also some miter saws with a dust-extraction structure on the market. Patent application CN108162078 discloses a dust-free and distance fine-tuning miter saw, a dust extraction guard is installed between the saw blade and the motor assemblies, a fan blade and a dust collection bag are mounted to the bottom end of the dust extraction guard, the dust extraction guard configures a first dust extraction tube and the second dust extraction tube, the dust generated by the saw blade cutting material is extracted into the first dust extraction tube and the second dust extraction tube, then into the dust collection bag, however, they do not have a lower dust extraction structure, meanwhile, they are not provided the rear protective guard and have a poor dust collection effect.

Therefore, there is an urgent need to invent a self-dust extraction dustless miter saw that has a simple structure, can realize self-dust extraction, has high dust extraction efficiency, and has a wide range of applications.

### SUMMARY

The object of this invention is to solve the shortcomings of the prior art and provide a self-dust extraction dustless miter saw.

The specific technical solution of the present invention are as follows:

The self-dust extraction dustless miter saw provided in the present invention comprises: the pedestal, the disc mounted on the pedestal, and the sawing mechanism installed above the disc, the said sawing mechanism comprises the saw blade, the blade guard installed above the saw blade, and the upper dust extraction channel; the upper dust extraction channel is arranged at the lower rear of the blade guard and is configured to extract most of the dust carried by the high-speed rotating saw blade while cutting;

the miter saw further comprises the lower dust extraction channel, the lower dust extraction channel is mounted to the rear of the disc, one end of the lower dust extraction channel is connected with the disc, and the other end of the lower dust extraction channel is connected with the self-dust extraction device of the miter saw through the pipe; the lower dust extraction channel comprises the dust outlet components;

the dust outlet components comprise the upper channel and the lower channel, wherein,

the upper channel has a curved groove structure for extracting the dust above the countertop of the disc;

the lower channel communicates with the cavity under the notch plate of the disc to extract the dust under the notch plate.

Preferably, the upper dust extraction channel comprises a rear protective guard and a guard guiding plate, the rear protective guard is mounted to the lower rear part of the blade guard via the saw blade shaft; guiding columns are on the outside of the rear protective guard and are far away from the saw blade shaft ends, the guard guiding plate is designed to have arc-shaped grooves and the arc-shaped grooves are near the ends of the saw blade shaft, the guiding columns are fitted into the arc-shaped grooves, the guard guiding plate is configured for pushing and pulling the rear protective guard.

Preferably, the dust guiding barrier and the dust extraction cover are mounted in the blade guard, the dust guiding barrier is closed to form the dust extraction cavity, and the dust extraction cavity is connected to the self-dust extraction device via the dust extraction inlet.

Preferably, the lower dust extraction channel further comprises the dust exhaust elbow, the pipe is the lower dust extraction inlet hose, one end of the dust exhaust elbow is connected to the dust outlet components, the other end of the dust exhaust elbow is connected to the dust extraction inlet in the blade guard of the miter saw through the lower dust extraction inlet hose.

Preferably, one side of the blade guard is connected to the self-dust extraction device for collecting all dust produced by the saw blade cutting material.

Preferably, the miter saw further comprises the dust collection bag, the collection bag is connected to the self-dust extraction device in the motor via the dust exhaust hose.

Preferably, the miter saw further comprises the self-dust extraction device, the self-dust extraction device is designed as a single fan blade.

Compared with the prior art, the beneficial effects of the present invention are:
1) in the present invention, the dust under the saw blade passes through the dust outlet components, the dust exhaust elbow, the lower dust extraction inlet hose enters the dust extraction cavity in the frame of the blade guard, and then enters the self-dust extraction device, wherein, the dust outlet components are designed as dual-channel, the dust under the notch plate enters the dust exhaust elbow through the lower channel of the dust outlet components, the dust above the countertop of the disc enters the dust exhaust elbow through the open-designed upper channel above the dust outlet components.
2) The unique design of the rea protective guard of the present invention enables the rear protective guard can be moved freely by pushing and pulling through the role of the guard guiding plate, meanwhile, the dust above the workpiece passes through the rear protective guard and enters the dust extraction cavity of the frame of the blade guard, and then enters the self-dust extraction device.
3) The self-dust extraction structure of the present invention is a single blade design, the air-duct for motor heat dissipation and the air-duct for extracting dust are cleverly separated through the unique design of the fan blade and the cooperation of the volute, which effectively solves the problem of dust extraction of the miter saw and has high efficiency of dust extraction.

### BRIEF DESCRIPTION OF THE DRAWINGS

FIG. 1 is an exploded view of the self-dust extraction dustless miter saw of the present invention;

FIG. 2 is a three-dimensional schematic diagram of the self-dust extraction dustless miter saw of the present invention;

FIG. 3 is a cross-sectional view of the saw blade of the self-dust extraction dustless miter saw of the present invention;

FIG. 4 is a schematic diagram of the saw blade of the self-dust extraction dustless miter saw of the present invention while cutting;

FIG. 5 is a second schematic diagram of the saw blade of the self-dust extraction dustless miter saw of the present invention while cutting;

FIG. 6 is a schematic diagram of the rear protective guard of the saw blade of the self-dust extraction dustless miter saw of the present invention;

FIG. 7 is a schematic diagram of the guard guiding plate of the saw blade of the self-dust extraction dustless miter saw of the present invention;

FIG. 8 is a partial view of the upper channel of the saw blade of the self-dust extraction dustless miter saw of the present invention;

FIG. 9 is another partial view of the upper channel of the saw blade of the self-dust extraction dustless miter saw of the present invention;

FIG. 10 is a front view of the upper channel of the saw blade of the self-dust extraction dustless miter saw of the present invention;

FIG. 11 is a schematic diagram of dust extraction cover of the self-dust extraction dustless miter saw of the present invention;

FIG. 12 is a schematic diagram of dust extraction inlet of the self-dust extraction dustless miter saw of the present invention;

FIG. 13 is a schematic diagram of the self-dust extraction structure of the self-dust extraction dustless miter saw of the present invention;

FIG. 14 is a schematic diagram of the air path of the self-dust extraction structure of the self-dust extraction dustless miter saw of the present invention;

FIG. 15 is a schematic diagram of the self-dust extraction dustless miter saw of the present invention when cut by pulling a rod;

FIG. 16 is a schematic diagram of the movement of guard guiding plate of self-dust extraction dustless miter saw of the present invention during a pushing forward cut;

FIG. 17 is a schematic diagram of the saw blade of the self-dust extraction dustless miter saw of the present invention in motion during a pushing forward cut;

FIG. 18 is another schematic diagram of the blade of the self-dust extraction dustless miter saw of the present invention in motion during a pushing forward cut;

### REFERENCE SIGNS OF THE DRAWINGS

1. The left-side blade guard, 2. The saw blade, 3. The rear protective guard, 4. The guard guiding plate, 5. The dust-extraction cover, 6. The right-side blade guard, 7. The volute A, 8. The volute B, 9. The windshield A, 10. The windshield B, 11. The armature component, 12. The stator, 13. The housing, 14. The housing rear cover, 15. The dust exhaust elbow, 16. The dust outlet components, 17. The notch plate, 18. The lower dust extraction inlet hose, 19. The protective cover, 20. The disc, 21. The pedestal, 22. The dust exhaust hose, 23. The dust collection bag, 24. The guiding column, 25. The arc-shaped groove, 26. The upper channel, 27. The lower channel, 28. The dust barrier, 29. The dust extraction inlet, 30. The dust extraction cavity, 31. The cut wood.

### DETAILED DESCRIPTION OF THE EMBODIMENTS

The present invention will be further described below in conjunction with the figures.

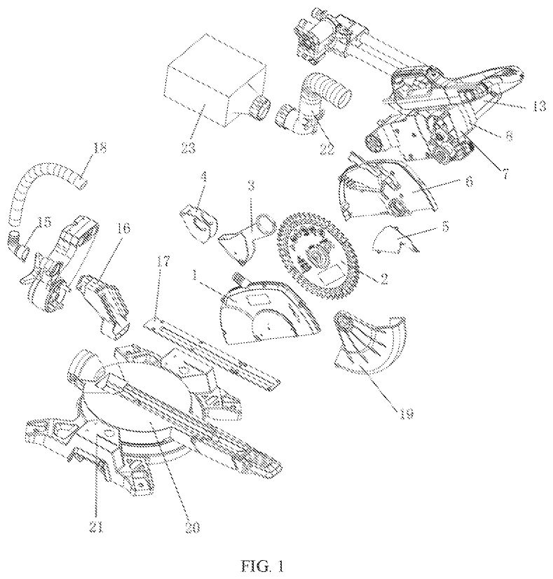

The self-dust extraction dustless miter saw was provided in the present invention, referring to FIGS. 1-2, comprises: the left-side blade guard 1, the saw blade 2, the rear protective guard 3, the guard guiding plate 4, the dust-extraction cover 5, the right-side blade guard 6, the volute A 7, the volute B 8, the windshield A 9, the windshield B 10, the armature component 11, the stator 12, the housing 13, the housing rear cover 14, the dust exhaust elbow 15, the dust outlet components 16, the notch plate 17, the lower dust extraction inlet hose 18, the protective cover 19, the disc 20, the pedestal 21, the dust exhaust hose 22 and the dust collection bag 23.

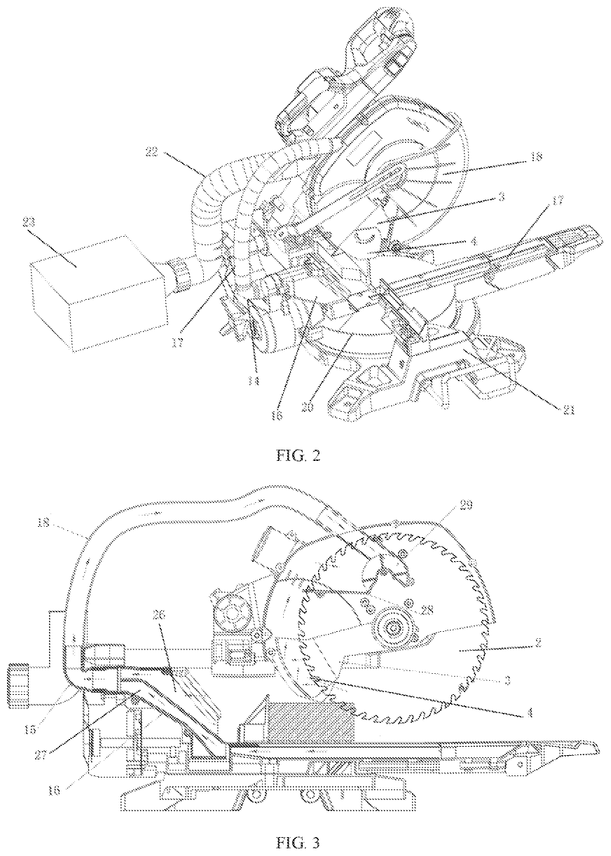

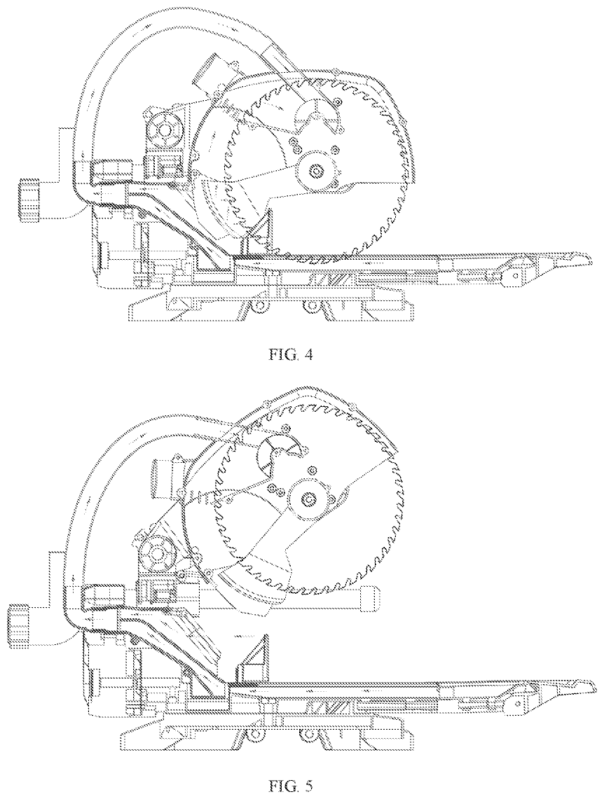

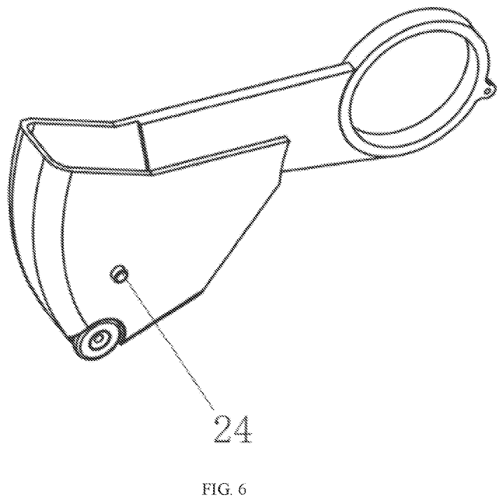

Specifically, referring to FIGS. 3-5, the self-dust extraction dustless miter saw provided in the present invention comprises: the pedestal 21, the disc 20 mounted on the pedestal, and the sawing mechanism installed above the disc, the said sawing mechanism comprises the saw blade 2, the blade guard installed above the saw blade, and the upper dust extraction channel, the blade guard comprises the left-side blade guard 1 and the right-side blade guard 6;

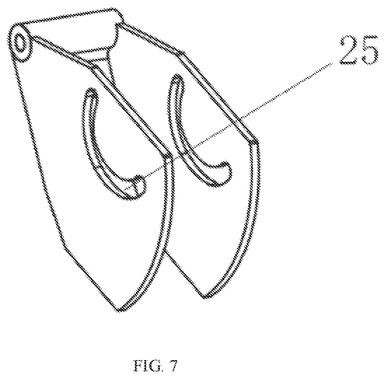

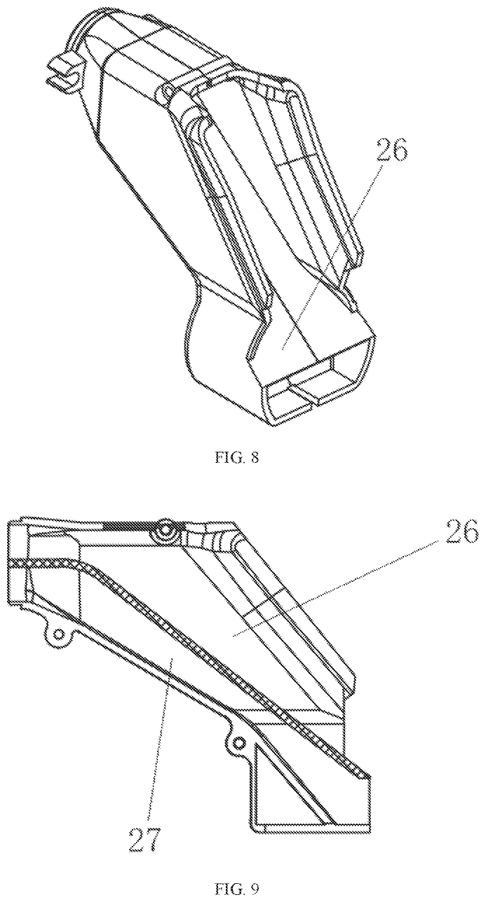

The upper dust extraction channel is arranged at the lower rear of the blade guard, and is configured to extract most of the dust carried by the high-speed rotating saw blade while cutting; the upper dust extraction channel comprises the rear protective guard 3 installed at the lower rear of the blade guard and the guard guiding plate 4 that assists the movement of the rear protective guard, referring FIGS. 6-7, the rear protective guard 3 is arranged at the lower rear part of the blade guard via the saw blade shaft; the guiding columns 24 are on the outside of the rear protective guard 3 and are far away from the saw blade shaft ends, the guard guiding plate 4 is designed to have the are-shaped grooves 25 which are near the ends of the saw blade shaft, the guiding columns 24 are fitted into the arc-shaped grooves 25, the guard guiding plate 4 is configured to push and pull the rear protective guard 3. Specifically, while cut by pulling, the rear protective guard 3 will naturally lift up and placed on the cut wood 31; while cut by pushing, the arc-shaped grooves 25 of the guard guiding plate 4 as waist holes are pushing the guiding columns 24 of the rear protective guard 3 to lift up the rear protective guard 3 and placed on the wood. The specific design allows the rear protective guard to be pushed and pulled freely, and at the same time enables the dust to be better guided into the dust extraction inlet along with the inner arc guide of the rear protective guard.

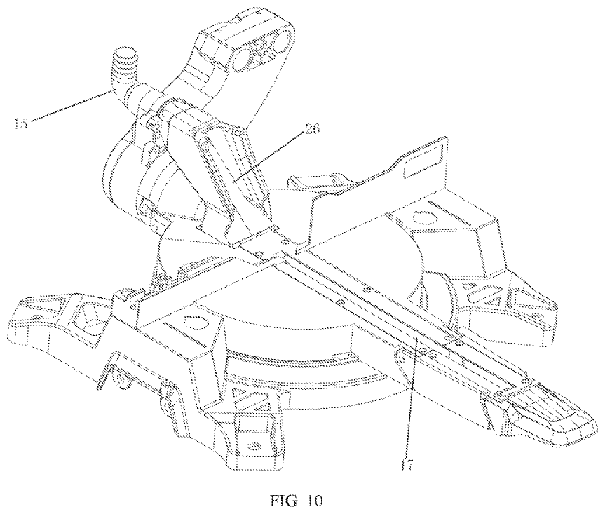

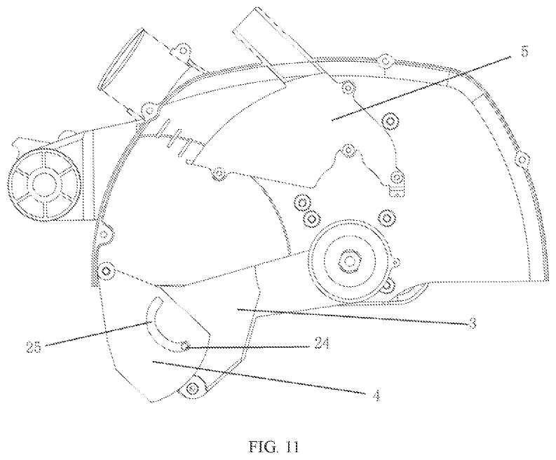

The miter saw further comprises the lower dust extraction channel, as shown in FIGS. 8-10, the lower dust extraction channel is designed as dual-channel, the lower dust extraction channel is mounted to the rear of the disc, one end of the lower dust extraction is connected with disc 20, and the other end of the lower dust extraction channel is connected with the self-dust extraction device of the miter saw through the pipe; the lower dust extraction channel comprises the dust outlet components 16 and the dust exhaust elbow 15, the pipe is the lower dust extraction inlet hose 18, one end of the dust exhaust elbow 15 is connected to the dust outlet components 16, the other end of the dust exhaust elbow is connected to the dust extraction inlet 29 in the blade guard of miter saw through the lower dust extraction inlet hose 18. That is, the other end of the dust outlet components 16 is connected to the dust extraction cavity 30 via the dust exhaust elbow 15, which the dust extraction cavity 30 is formed by the lower dust extraction inlet hose 18, the dust extraction cover 5 in the blade guard, and the dust guiding barrier 28 comprised in the blade guard; the dust outlet components 16 comprises upper channel 26 and lower channel 27, in which the upper channel 26 has a curved groove structure with an open design, similar to a slide, for extracting the dust above the countertop of the disc; the lower channel 27 communicates with the cavity under the notch plate of the disc to extract the dust under the notch plate 17.

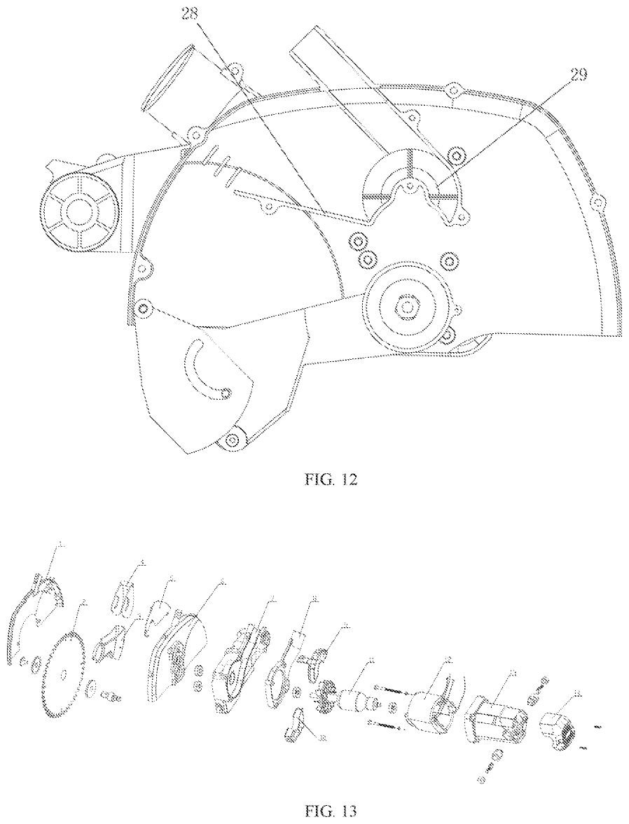

The dust guiding barrier 28 and the dust extraction cover 5 are mounted in the blade guard, as shown in FIGS. 11-12, the dust guiding barrier 28 is closed to form the dust extraction cavity 30, and the dust extraction cavity is connected to the self-dust extraction device via the dust extraction inlet 29. One side of the blade guard (the right-side blade guard) is connected to the self-dust extraction device for collecting all dust generated by cutting material by the saw blade.

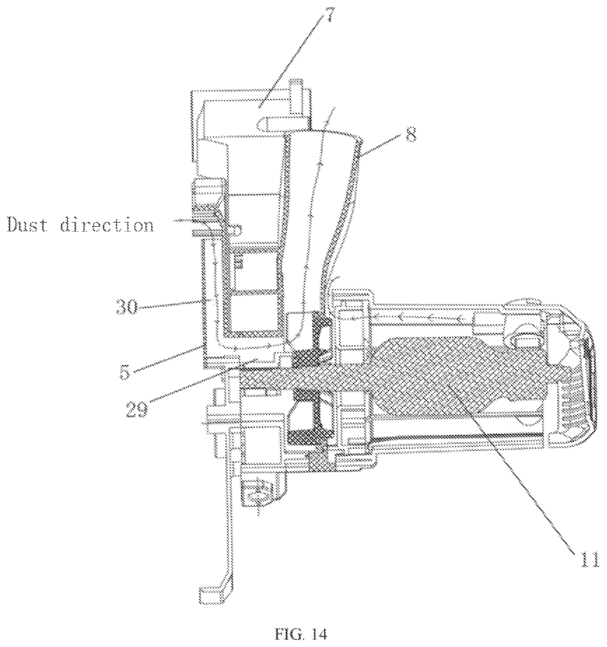

The miter saw further comprises the dust collection bag 23, the collection bag is connected to the self-dust extraction device in the motor via the dust exhaust hose 22. The miter saw further comprises the self-dust extraction device, the self-dust extraction device is a single fan blade design. Specifically, as shown in FIGS. 13-14, the self-dust extraction structure of the single fan motor comprises in turn: the left-side blade guard 1, the saw blade 2, the rear protective guard 3, the guard guiding plate 4, the dust extraction cover 5, the right-side blade guard 6, the volute A 7, the volute B 8, the windshield A 9, the windshield B 10, the armature component 11, the stator 12, the housing 13, and the housing rear cover 14.

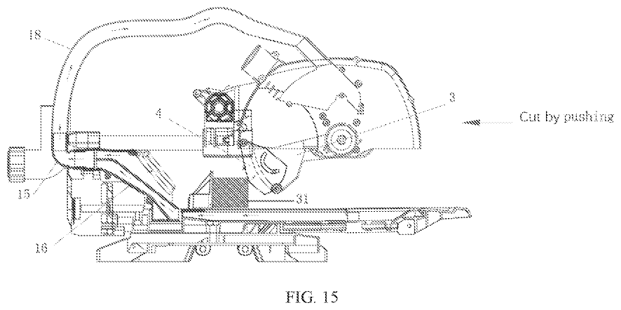

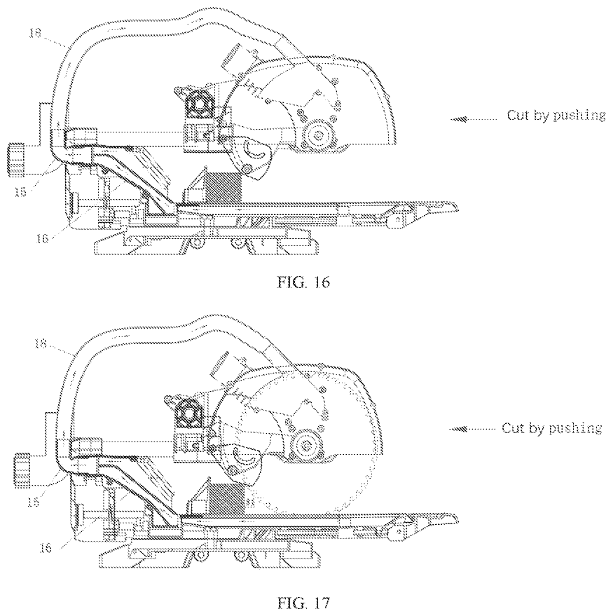

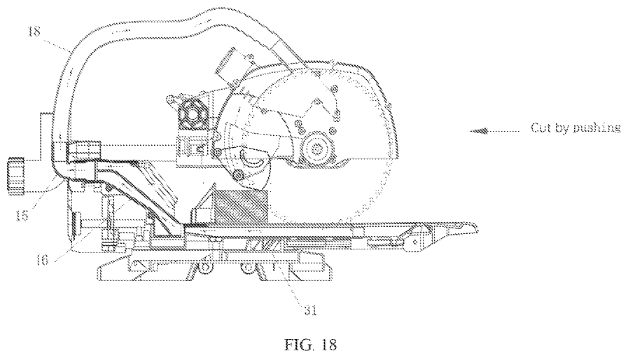

Referring to FIGS. 15-18, the specific working process of the present invention is: the guard guiding plate 4 will always keep the rear protective guard 3 on the wood when cutting the wood 31. Most of the wood chips produced during high-speed rotation cutting follow the rotation of the saw blade and pass through the rear protective guard 3 into the blade guard along the arc, and finally into the dust extraction cavity enclosed by the dust extraction covers and the dust guiding barrier 28.

When cutting, a small part of the dust that on of the disc and at the rear of the wood will enter the upper channel 26 of the dust outlet component 16, the other small part of the dust below the notch plate 17 will enter the lower channel 27 of the dust outlet component 16, and then the dust in both channels of the dust outlet components will enter the dust exhaust elbow 15 together, and then through the lower dust extraction inlet hose 18 enter the dust extraction cavity 30 that in the blade guard and enclosed by the dust extraction cover 5 and the dust guiding barrier 28.

Finally, most of the wood chips produced during high-speed rotation cutting and the small part of wood chips on the disc and below the notch plate while cutting are collected in the dust extraction cavity 30, and then all the collected dust enters the dust extraction inlet 29 at the same time, then passed through the components of the self-dust extraction device, enters the dust exhaust hose 22, and then to dust collection bag 23, and finally achieves the purpose of extracting dust.

The present invention has the dust extraction design of the dual-channel located under the rear of the saw blade and the unique dust extraction design of the rear protective guard located above the rear of the saw blade and achieves the maximum effect of dust extraction through the design of vacuum dust extraction channel in the blade guard.

Any content not described in detail in the present invention can configure conventional technical knowledge in the art.

Finally, it should be noted that the above embodiments are only configured for describing instead of limiting the technical solutions of the present invention. Although the present invention is described in detail with reference to the embodiments, persons of ordinary skill in the art should understand that modifications or equivalent substitutions of the technical solutions of the present invention should be encompassed within the scope of the claims of the present invention so long as they do not depart from the spirit and scope of the technical solutions of the present invention.

What is claimed is:

1. A self-dust extraction dustless miter saw, comprising
a pedestal, a disc mounted on the pedestal, and a sawing mechanism installed above the disc, wherein the sawing mechanism comprises a saw blade, a blade guard installed above the saw blade, and an upper dust extraction channel;
the upper dust extraction channel is arranged at a lower rear of the blade guard and the upper dust extraction channel is configured to extract a dust carried by the saw blade at a high rotation speed while cutting;
the self-dust extraction dustless miter saw further comprises a lower dust extraction channel, the lower dust extraction channel is mounted to a rear of the disc, a first end of the lower dust extraction channel is connected with the disc, and a second end of the lower dust extraction channel is connected with a self-dust extraction device of the self-dust extraction dustless miter saw through a pipe;
the lower dust extraction channel comprises dust outlet components;
the dust outlet components comprise an upper channel and a lower channel, wherein,
the upper channel has a curved groove structure for extracting the dust above a countertop of the disc; and
the lower channel communicates with a cavity under a notch plate of the disc to extract the dust under the notch plate.

2. The self-dust extraction dustless miter saw according to claim 1, wherein the upper dust extraction channel comprises a rear protective guard and a guard guiding plate, the rear protective guard is mounted to the lower rear of the blade guard via a saw blade shaft;
guiding columns are on an outside of the rear protective guard and the guiding columns are far away from ends of the saw blade shaft, the guard guiding plate is designed to have arc-shaped grooves, and the arc-shaped grooves are near the ends of the saw blade shaft, the guiding columns are fitted into the arc-shaped grooves, the guard guiding plate is configured for pushing and pulling the rear protective guard.

3. The self-dust extraction dustless miter saw according to claim 1, wherein both a dust guiding barrier and a dust extraction cover are mounted in the blade guard, the dust guiding barrier is closed to form a dust extraction cavity, and the dust extraction cavity is connected to the self-dust extraction device via a dust extraction inlet.

4. The self-dust extraction dustless miter saw according to claim 1, wherein the lower dust extraction channel further comprises a dust exhaust elbow, the pipe is a lower dust extraction inlet hose, a first end of the dust exhaust elbow is connected to the dust outlet components, a second end of the dust exhaust elbow is connected to a dust extraction inlet in the blade guard of the self-dust extraction dustless miter saw through the lower dust extraction inlet hose.

5. The self-dust extraction dustless miter saw according to claim 1, wherein one side of the blade guard is connected to the self-dust extraction device for collecting the dust produced by saw blade cutting materials.

6. The self-dust extraction dustless miter saw according to claim 1, further comprising a dust collection bag, wherein the dust collection bag is connected to the self-dust extraction device in a motor via a dust exhaust hose.

7. The self-dust extraction dustless miter saw according to claim 1, further comprising the self-dust extraction device, wherein the self-dust extraction device is designed as a single fan blade.
